(19) United States
(12) Patent Application Publication
(10) Pub. No.: US 2024/0372780 A1
(43) Pub. Date: Nov. 7, 2024

(54) INFORMATION TECHNOLOGY ASSET MANAGEMENT SYSTEM FOR PROVIDING SERVER CONFIGURATION AUTOMATION

(71) Applicant: GeniaI CO.,LTD, Seoul (KR)

(72) Inventor: Se Kweon YOO, Seoul (KR)

(21) Appl. No.: 18/644,356

(22) Filed: Apr. 24, 2024

(30) Foreign Application Priority Data
Apr. 24, 2023 (KR) 10-2023-0053118

(51) Int. Cl. H04L 41/08; H04L 41/0659; H04L 41/0686; H04L 41/082

(52) U.S. Cl. CPC H04L 41/0886; H04L 41/0661; H04L 41/0686; H04L 41/082

(57) ABSTRACT

Provided is an IT asset management system for managing an IT asset including two or more management target servers, including: a database for storing data related to the management target servers; and a management server collecting a hardware-related data and a software-related data from the management target servers, monitoring and managing a status of each management target server, and providing various server monitoring information, including management service statistical data and management service reports, to an administrator terminal used by an administrator and a customer terminal requesting the management target server, wherein the management server provides a server configuration automation function in a way where unique setting values of each management target server are stored as a metadata in a SCP (Server configuration profile). There is an effect capable of preventing faults being likely to occur in the servers in advance and of reducing damages due to the server faults.

### CROSS-REFERENCE TO RELATED APPLICATION(S)

This application is based upon and claims the benefit of priority from Korean Patent Application No. 10-2023-0053118, filed on Apr. 24, 2024, the entire contents of which are incorporated herein by reference.

### TECHNICAL FIELD

The present invention relates to a management technology for systemizing and standardizing IT (Information Technology) assets such as servers, storage, and networks, and more specifically, relates to a server management technology for providing a function of automating server configuration.

### BACKGROUND

Recently, the IT (Information Technology) environment, including servers, storage, and networks, has become more complex, and a phenomenon that work time has become scarce has been occurring. As computer systems become larger in capacity and faster in speed, computer failures due to system errors or viruses have been occurring frequently. In particular, in the case of large-capacity servers, failures can occur frequently due to various factors such as the operation of various application programs and data storage, reading, and transmission. Therefore, each company has a separate server administrator who manages these servers and handles the failure when the failure occurs.

However, server management requires specialized skills, and hiring such specialized personnel requires significant costs. Therefore, especially in small companies, rather than hiring a professional engineer as the server administrator, the small companies select appropriate person from among existing personnel within the companies and appoint the person as the server administrator. In that case, it is difficult to manage the server smoothly, and furthermore, it is almost impossible to respond smoothly in the event of the server fault.

In addition, even if a server administrator with specialized skills is hired to manage the server, in a case where the server administrator is remote from the server due to a business trip or other reasons, when a server fault occurs, it is difficult to quickly notify the administrator of the server situation. It is difficult to respond smoothly in the event of a server fault. Moreover, even if the server administrator is notified of the occurrence of the server fault, since the administrator is located at a remote location, is difficult to respond immediately to this server fault, and thus, this can result in massive losses such as the server down.

In the related art, in the server integrated management system that integrates and manages a number of servers, if a fault occurs in a server, the fault is detected and the fault is repaired afterwards. However, a post-fault recovery method of the related art, the operation of the server in question is interrupted during the cycle of recovery of the failed server, and there is a problem in that massive losses occur due to server use interruption, and the manpowers and costs required for recovery are large.

The Patent Literature is Korean Patent Application Publication No. 210-015-0124642.

### SUMMARY

In order to solve the above problems, the present invention is to provide an IT asset management system capable of improving operational efficiency, reduce operating costs, and strengthen security by systematizing IT assets and standardizing work.

The object of the present invention is not limited to the object mentioned above, and other objects not mentioned will be clearly understood by those skilled in the art from the description below.

In order to achieve this objects, the present invention relates to an IT asset management system for managing an IT asset including two or more management target servers, including: a database for storing data related to the management target servers; and a management server collecting a hardware-related data and a software-related data from the management target servers, monitoring and managing a status of each management target server, and providing various server monitoring information, including management service statistical data and management service reports, to an administrator terminal used by an administrator and a customer terminal requesting the management target server, wherein the management server provides a server configuration automation function in a way where unique setting values of each management target server are stored as a metadata in a SCP (Server configuration profile).

The management server provides the server configuration automation function by using Redfish API. The management server distributes SCP to the management target server newly built so that configuration information is applied.

According to the present invention, through management of a number of management target servers, by predicting faults being likely to occur in the servers preemptively and providing warnings and a solution, there is an effect capable of preventing faults being likely to occur in the servers in advance and of reducing damages due to the server faults.

In addition, according to the present invention, there is an effect capable of improving operational efficiency, reducing operating costs, and strengthening security by systematizing IT assets and standardizing work.

In addition, according to the present invention, there is an effect capable of managing a number of servers more conveniently and efficiently.

In addition, according to the present invention, by providing a server management function of analyzing fault patterns to preemptively respond to faults in advance to a customer requesting the server management, there is an effect capable of processing and transferring data to suit needs of the customer.

### BRIEF DESCRIPTION OF THE DRAWINGS

FIG. 1 is a diagram conceptually showing an overall configuration of an IT asset management system according to an embodiment of the present invention;

FIG. 2 is a diagram conceptually showing operation processes in the IT asset management system according to the embodiment of the present invention;

FIG. 3 is a flowchart showing a method for automating server configuration in the IT asset management system according to the embodiment of the present invention;

FIGS. 4, 5, 6, 7 and 8 are screen examples displaying functions provided by the IT asset management system according to the embodiment of the present invention;

FIG. 9 is a diagram showing a configuration example in the IT asset management system according to the embodiment of the present invention;

FIG. 10 is an exemplary diagram showing a server monitoring function through Redfish events in the IT asset management system according to the embodiment of the present invention;

FIG. 11 is an exemplary diagram showing a server configuration automation function through Redfish in the IT asset management system according to the embodiment of the present invention;

FIG. 12 is an exemplary diagram showing the server configuration automation function through Redfish in the IT asset management system according to the embodiment of the present invention;

FIG. 13 is a flowchart exemplarily showing a method for managing a server by supporting multi-vendor in the IT asset management system according to the embodiment of the present invention;

FIG. 14 is a flowchart exemplarily showing a method for preventing failures in advance by analyzing logs and patterns of failures in the IT asset management system according to the embodiment of the present invention;

FIG. 15 is a diagram exemplarily showing an operation model supporting multi-vendors by using the Redfish API in the IT asset management system according to the embodiment of the present invention;

FIGS. 16, 17, 18, 19, 20, 21, 22, 23, 24, 25, 26, 27, 28 and 29 are diagrams showing screen examples of the IT asset management system according to the embodiment of the present invention;

FIG. 30 is a table classifying system devices according to the embodiment of the present invention;

FIGS. 31 and 32 are tables describing hardware symptoms and their causes according to the embodiment of the present invention; and

FIGS. 33 and 34 are flowcharts showing a method for responding to faults proactively in the IT asset management system according to the embodiment of the present invention.

### DETAILED DESCRIPTION

Since the present invention can make various changes and have various embodiments, specific embodiments will be illustrated in the drawings and described in detail. However, this is not intended to limit the present invention to specific embodiments, and should be understood to include all changes, equivalents, and substitutes included in the spirit and technical scope of the present invention. The terms used in present application are only used to describe specific embodiments and are not intended to limit the invention. Singular expressions include plural expressions unless the context clearly dictates otherwise. In present application, terms such as “comprise” or “have” are intended to designate the presence of features, numbers, steps, operations, components, parts, or combinations thereof described in the specification, but are not intended to indicate the presence of one or more other features. It should be understood that this does not exclude in advance the possibility of the existence or addition of elements, numbers, steps, operations, components, parts, or combinations thereof. Unless otherwise defined, all terms used herein, including technical or scientific terms, have the same meaning as commonly understood by an ordinary skilled person in the technical field to which the present invention relates. Terms such as those defined in commonly used dictionaries should be interpreted as having meanings consistent with the meanings in the context of the related technology, and should not be interpreted in an idealized or overly formal sense unless explicitly defined in the present application.

In addition, in the description with reference to the accompanying drawings, the same components will be assigned the same reference numerals regardless of the reference numerals, and duplicate descriptions thereof will be omitted. In the description of the present invention, in the case where it is determined that a detailed description of related known technologies may unnecessarily obscure the spirit of the present invention, the detailed description will be omitted.

The present invention relates to an IT asset management system for managing an IT asset including two or more management target servers, including: a database for storing data related to the management target servers; and a management server collecting a hardware-related data and a software-related data from the management target servers, monitoring and managing a status of each management target server, and providing various server monitoring information, including management service statistical data and management service reports, to an administrator terminal used by an administrator and a customer terminal requesting the management target server, wherein the management server provides a server configuration automation function in a way where unique setting values of each management target server are stored as a metadata in a SCP (Server configuration profile).

The management server provides the server configuration automation function by using Redfish API.

The management server distributes SCP to the management target server newly built so that configuration information is applied.

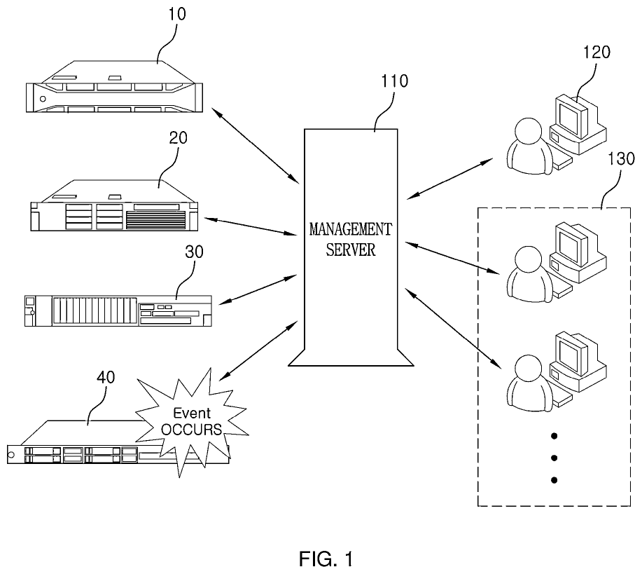

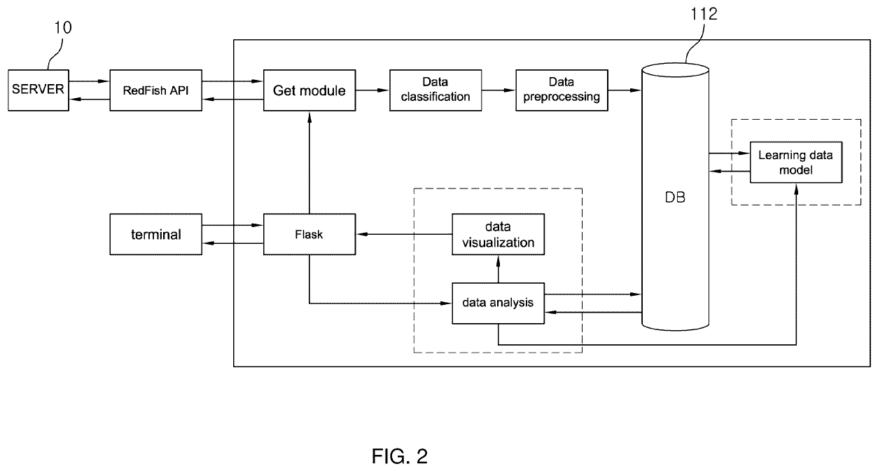

FIG. 1 is a diagram conceptually showing an overall configuration of the IT asset management system according to the embodiment of the present invention, and FIG. 2 is a diagram conceptually showing operation processes in the IT asset management system according to the embodiment of the present invention.

Referring to FIGS. 1 and 2, the IT asset management system of the present invention includes a management server 110, a database 112, an administrator terminal 120, and a customer terminal 130.

The administrator terminal 120 is a terminal used by an administrator who manages the IT asset management system.

The customer terminal 130 is a terminal used by each customer who has requested the management target servers 10, 20, 30, and 40.

In one embodiment of the present invention, the administrator terminal 120 and the customer terminal 130 may be implemented in various terminal forms capable of wired and wireless communication, such as desktop computers, laptop computers, tablet PCs, portable phones, mobile phones, and smart phones. In one embodiment of the present invention, the user terminal is a concept that includes the administrator terminal 120 and the customer terminal 130.

The database 112 stores data related to the management target servers 10, 20, 30, and 40.

The management server 110 collects data from the management target servers 10, 20, 30, and 40, identifies and manages the status of each management target server, and provides various server management information including management service statistical data and management service reports related thereto to the administrator terminal 120 and the customer terminal 130.

The management server 110 can collect and store multi-vendor hardware information from a plurality of management target servers and provide the information to the administrator terminal 120 and the customer terminal 130 so that the stored information can be queried and used.

The management server 110 may collect and store multi-vendor hardware inventory information from a plurality of registered management target servers.

When there is a firmware update event including an emergency firmware update, the management server 110 may perform a firmware update for all the management target servers.

The management server 110 analyzes logs and patterns when an issue of the fault occurs in any device of the management target server, stores the analyzed data and, when the issue of the fault is resolved, classifies devices similar to the relevant device, and can perform pre-fault response processing proactively for classified similar device.

The management server 110 can use the Redfish API to collect information about an x86 server in operation including detailed hardware specifications, operating system (OS) information, firmware information, driver information, and the like of each management target server and can perform standardization management of the x86 servers.

The management server 110 can provide a preventive analysis function of analyzing the fault patterns of the management target servers 10, 20, 30, and 40 and preventing similar faults from occurring and can proactively transmit a predicted fault occurrence message warning that a fault may occur due to the occurrence of the event occurring when a predetermined event from the management target servers 10, 20, 30, and 40 to the customer terminal requesting the management target server through the preventive analysis function.

The management server 110 may provide a history management function of managing an installation, fault and a technical support history of the management target servers 10, 20, 30, and 40.

The management server 110 may provide a delivery management function of managing a delivery history of the management target servers 10, 20, 30, and 40.

When a device-related event occurs in the management target server, the management server 110 can classify hazardous devices in advance according to classification criteria and can transmit an alert message about the hazardous device to the administrator terminal 120 and the relevant customer terminal, and can perform fault response measures proactively for the hazardous device.

When a device-related event occurs in the management target server, the management server 110 identifies a fault symptom of the device, analyzes a cause of the fault corresponding to a symptom code for each fault symptom, transmits a report including fault response measures to the administrator terminal 120 and the customer terminal 130, and performs the fault response measures for the relevant device.

In the present invention, the management server 110 can provide a data delivery service function of processing and transferring data related to the management of the management target server according to the request of the customer terminal 130.

In addition, the management server 110 can prevent server faults proactively by analyzing critical faults of the management target servers and disseminating the same cases and can provide quarterly fault statistics of each server to the administrator terminal 120 and the customer terminal 130.

In the present invention, the management server can manage the history of delivered server-related devices, can provide installation/fault/technical support history management services, and can manage issues for each part.

The present invention relates to a sever management system for managing a number of management target servers (10, 20, 30, and 40) requested by customers.

In one embodiment of the present invention, the management target server, which is the server subject to management, may be various servers, and can be, for example, a Dell server 10, a HP server 20, a Lenovo server 30, and X86 server 40.

The management target servers 10, 20, 30, and 40 and the management server 110 communicate through various wired and wireless communication methods, and can communicate through, for example, HTTP communication or JSON format POST transmission method.

In addition, the management target servers 10, 20, 30, and 40 can automatically perform scripts according to scheduling set in on various x86 servers in a large-scale computing environment.

The administrator connects to the management server 110 through the administrator terminal 120, executes a BATCH program according to the scheduling set in the management server 110, compares results of the execution with existing data, and manages the change history.

The management server 110 automatically collects hardware information and software information of the management target servers 10, 20, 30, and 40, the status of each server is identified based on the collected information, and provides a management service in accordance with the required situation of each server.

FIG. 2 is a diagram conceptually showing operation processes in the sever management system according to the embodiment of the present invention. In FIG. 2, the management target server is a Dell server 10 to which iDRAC9 version is applied, and a platform using Redfish API (Application Programming Interface) is exemplarily shown.

Referring to FIG. 2, Get Module is performed by using Flask on the user terminal, and iDRAC9 structured data and unstructured data are collected from the Dell server 10 by using Redfish API. Then, the collected data is classified, and data preprocessing is performed. Then, the preprocessed data is stored in the database 112, and learning is performed on the data stacked in the database through an AI learning data model to reclassify the data and generate a data row.

Then, by using Flask on the user terminal, the page is called, the data analysis module searches the database 112, analysis is performed, data visualization is performed, and results of the data visualization is transferred to the Flask Response User Web page.

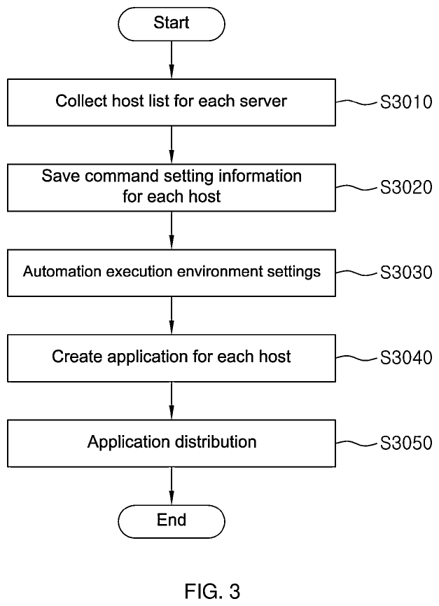

FIG. 3 is a flowchart showing a method of implementing an artificial intelligence (AI) analysis function in an IT asset management system according to an embodiment of the present invention. The embodiment in FIG. 3 is an embodiment using the Redfish API.

Referring to FIG. 3, the management server 110 stores information including OS, BIOS, Firmware, and the like collected from each management target server (S2010).

The management server 110 distributes firmware to the relevant management target server when a firmware update event such as an emergency firmware update occurs (S2020 and S2030).

The management server 110 confirms the firmware information of the management target server (S2040) and confirms whether or not the firmware update is complete (S2050).

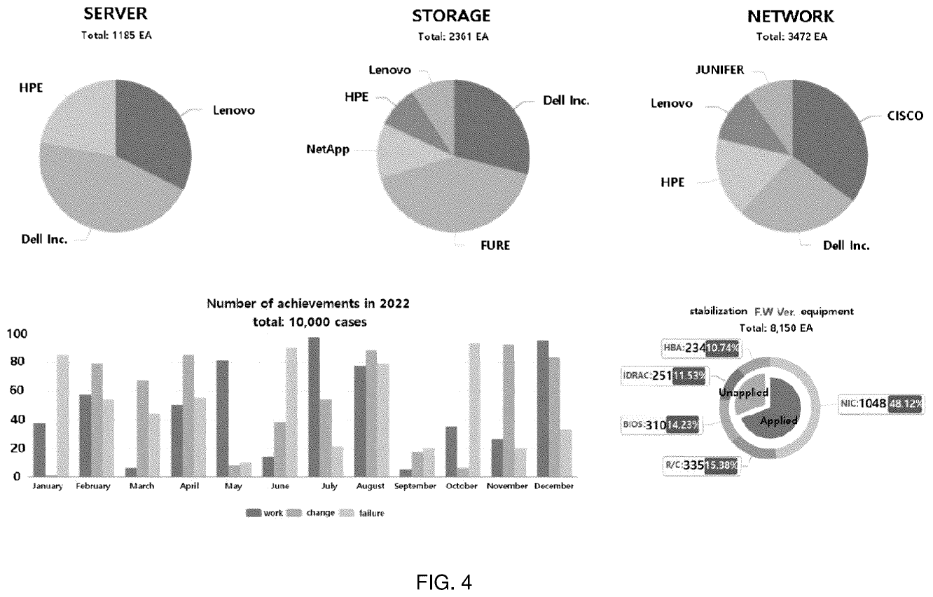

FIGS. 4 to 8 are screens examples displaying functions provided by the IT asset management system according to the embodiment of the present invention.

FIG. 4 is a screen example of a main dashboard screen.

Referring to FIG. 4, the management server 110 provides one main dashboard screen of organizing and displaying asset information collected from the management target servers 10, 20, 30, and 40 and important information about one screen based on the number of registered results, and the like.

The present invention can analyze specific information in depth to support continuous monitoring, can provide various information about which device the user frequently uses and which tasks the user spend a lot of time on, and whether or not stabilization firmware for each component of management target server is applied through the dashboard screen, and can provide management target server information so that users can confirm important management target server information at a glance through the dashboard screen.

In the screen example of FIG. 4, the information about server, storage, and network operation status is displayed, and a pie chart of the total number in in operation and the numbers for each server manufacturer is provided.

In addition, the present invention provides status information about the number of monthly achievements and provides bar charts for the number of tasks, changes, and achievements of faults.

In addition, in displaying information about the status of application of stable firmware, a chart is provided for the stabilization application ratio, which is a ratio of devices with and without stable firmware such as BIOS, R/C, NIC, iDRAC, HBA, and the like.

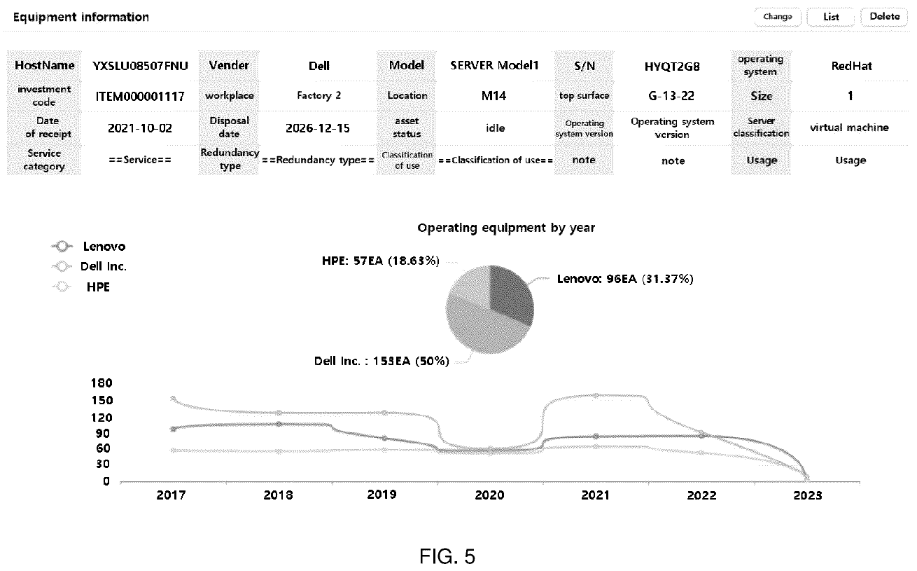

FIG. 5 is a screen example displaying the asset management function.

In the present invention, the management server 110 provides an asset management function of automatically collecting and organizing new installation and change lists of devices such as servers to provides highly reliable data in real time.

The management server 110 can collect registered information from user terminals in the asset management function or can automatically collect asset information about servers in the data center proactively according to a predefined cycle through the standardized Redfish RESTful API.

In the screen example of FIG. 5, device information is displayed, and the device information such as servers, storage, networks, SANs, backup device, and discarded devices can be registered or queried.

In addition, related statistical graphs are provided, a pie chart for device status such as operating, idle, out-of-service, discarding, and the like are provided, and various statistical graphs are provided for related statistical information about the status of operating device by year and vendor, a list of recently registered device, additional customization methods, and the like.

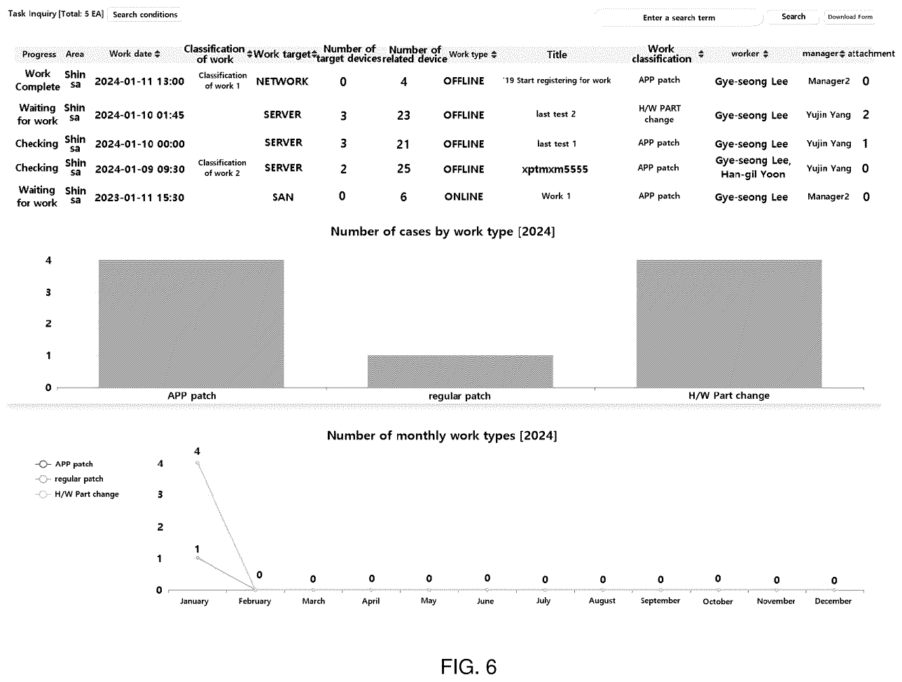

FIG. 6 is a screen example displaying the performance management function.

In the present invention, the management server 110 provides the performance management function for managing scheduled tasks, specifications of changes due the to the tasks, and the like., and managing the history after the occurrence of faults and improvement results.

Through this, in the present invention, when the cause of a fault is clear, records can be managed to prevent the same fault from occurring, a person, the person in charge can be assigned to matters requiring improvement, and the improvement results can be confirmed.

In addition, various performance status statistical information can be provided according to status such as year, month, data center location, before operation service, idle, and the like.

In the screen example of FIG. 6, a work history including online or offline work history management, fault history by fault handling history, administrator, change history by system change history administrator, and the like are displayed, and various statistical graphs about backup schedule management and performance status are displayed.

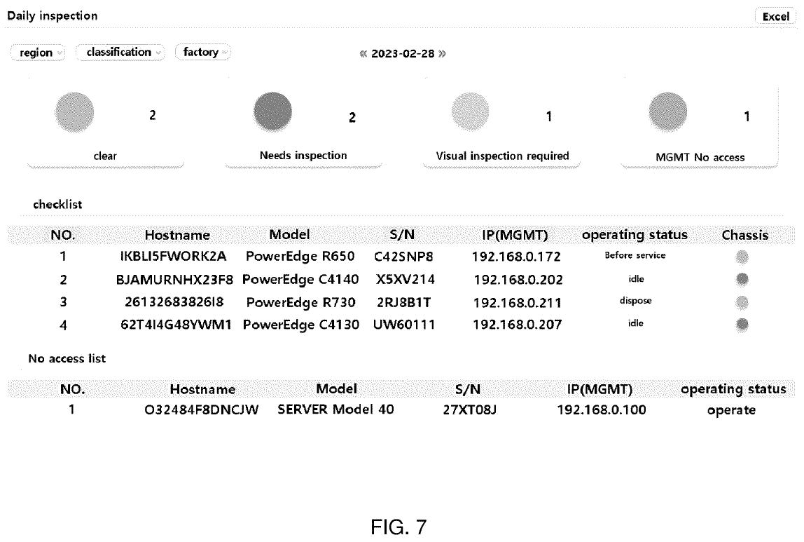

FIG. 7 is a screen example displaying an automated management function.

In the present invention, the management server 110 provides an automation management function of providing notification information through setting the synchronization cycle (Daily/Weekly/Monthly) though and setting automatically collected values (all /Chassis/MGMT/CPU/NIC/HBA/DISK/GPU, and the like) through the standardized Redfish RESTful API, group-specific execution cycle management for automated collection of schedule information registration and the like, and daily automatic inspection for inspection-required target device.

In the screen example of FIG. 7, displayed is a daily inspection menu capable of confirming settings of the collection synchronization cycle, user-defined settings of automated collection values, automation settings for registering collection schedule information, automatic classification of devices requiring daily inspection, and devices with MGMT (Management Repository) connection errors.

As shown in FIG. 7, the management server 110 can display a daily inspection menu in different colors depending on the status of the device. In other words, if there is no problem with the device, symbol 1 ( [symbol] ) is displayed; if inspection by the administrator is required, which is ‘inspection required’, symbol 2 ( [symbol] ) is displayed; if visual inspection is required, which is ‘visual inspection required’, symbol 3 ( [symbol] ) is displayed; and if MGMT cannot be connected, which is ‘MGMT inaccessible’, symbol 4 ( [symbol] ) is displayed.

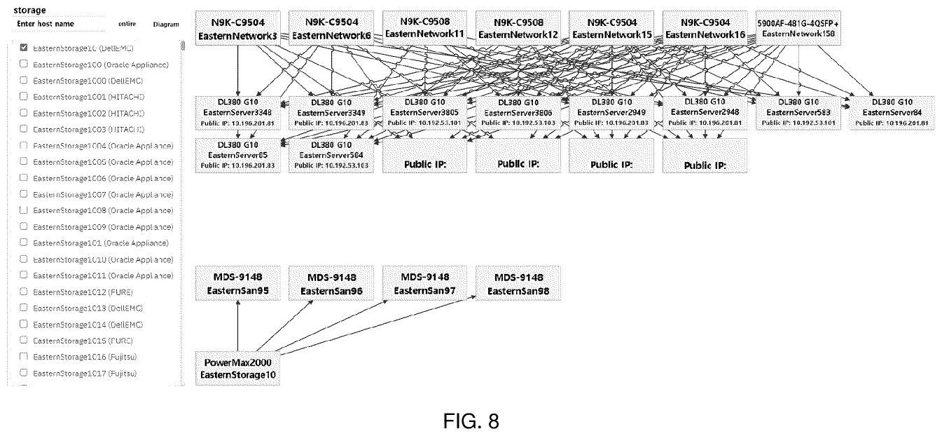

FIG. 8 is a screen example displaying configuration diagram management.

In the present invention, the management server 110 provides a configuration diagram management function, which is a configuration diagram view function required to efficiently operate and manage an IT infrastructure environment such as servers, storage, networks, and SANs, which are IT infrastructure components.

In other words, the management server 110 provides a configuration diagram management function of automatically displaying a view of the configuration of the assets selected from the user terminal, such as servers, storage, networks, SANS, and the like., and through this, issues of performance and enables faster decision-making in the event of a fault.

Referring to FIG. 8, the configuration diagram management function provides a view function of the configuration diagram of devices (servers, storage, networks, SANs, and the like) selected from the user terminal, and provides search and selection functions based on hostname and device model, so as to confirm real-time infrastructure configuration in the occurrence of performance issues or faults.

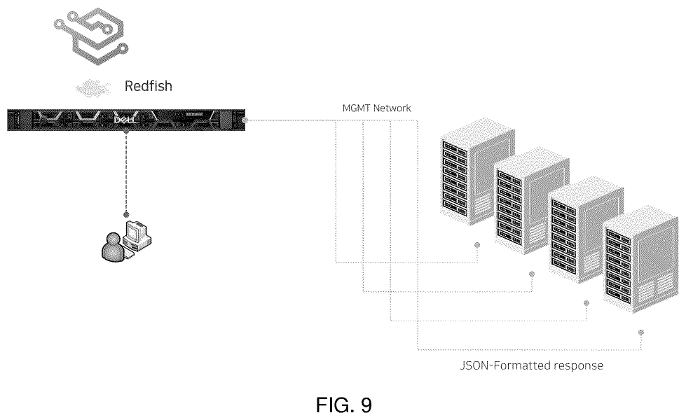

FIG. 9 is a diagram showing a configuration example of the IT asset management system according to the embodiment of the present invention.

In the configuration example of FIG. 9, the Redfish API is used, the management target server is connected through the MGMT network, and the administrator terminal 120 can access the management target server through web connection.

In one embodiment of the present invention, the IT asset management system is a Redfish API-based platform that collects inventory information of hardware systems of multi-vendor x86 servers in real time and distributes BIOS settings, firmware, and the like.

This can result in increased maintenance efficiency and reduced operating costs.

In addition, similar device can be identified based on collected logs to prevent similar faults proactively.

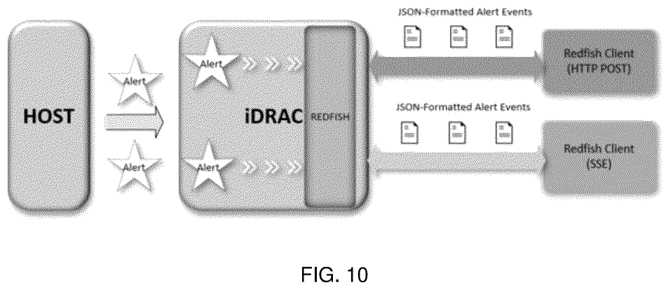

FIG. 10 is an exemplary diagram showing the server monitoring function through the Redfish events in the IT asset management system according to the embodiment of the present invention.

Referring to FIG. 10, in the present invention, the management server 110 can provide the server monitoring function through the Redfish events.

The Redfish events transmit event information from the server to the Redfish client based on HTTPS, and when an alarm occurs in the management, the information can be transmitted through HTTP POST and can be received through HTTP GET. At this time, the target server for push of important notification emails, status monitoring, and daily inspection is selected, and the necessary data can be loaded.

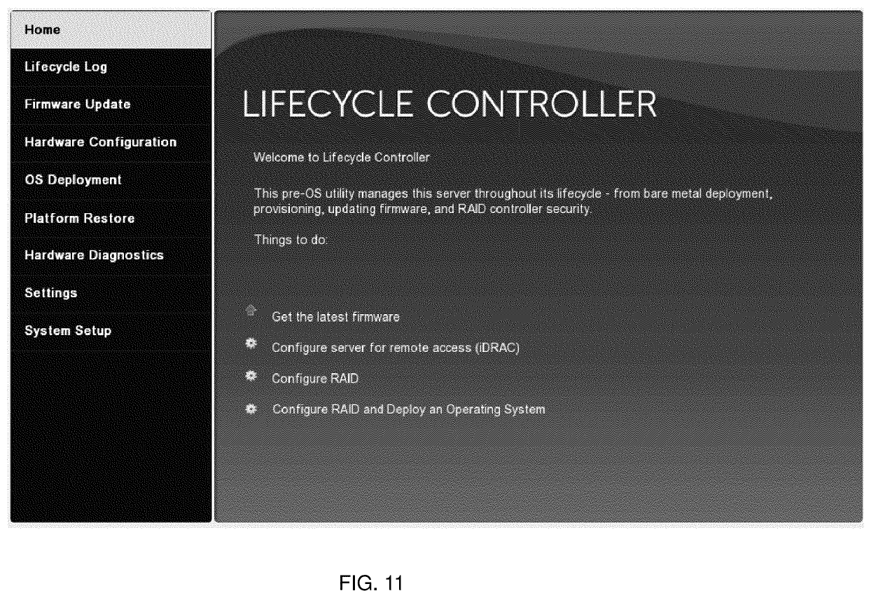

FIG. 11 is an exemplary diagram showing the server configuration automation function through the Redfish in the IT asset management system according to the embodiment of the present invention.

Referring to FIG. 11, in the present invention, the management server 110 can provide the server configuration automation function through the Redfish. In this function, BIOS settings change, secure boot, iDRAC configuration, and the like can be locally distributed and updated. In addition, provided are management target server firmware inventory management and updates, and the distribution time can be shortened by applying BIOS standard settings and management standard configuration values in batches during distribution of servers, and through the automated management functions, erroneous setting value can be prevented from being entered. In addition, by updating the firmware information installed on the management target server according to a preset cycle, a function of automatically selecting the target devices are during urgent distribution, firmware and pushing an e-mail is provided to the administrator.

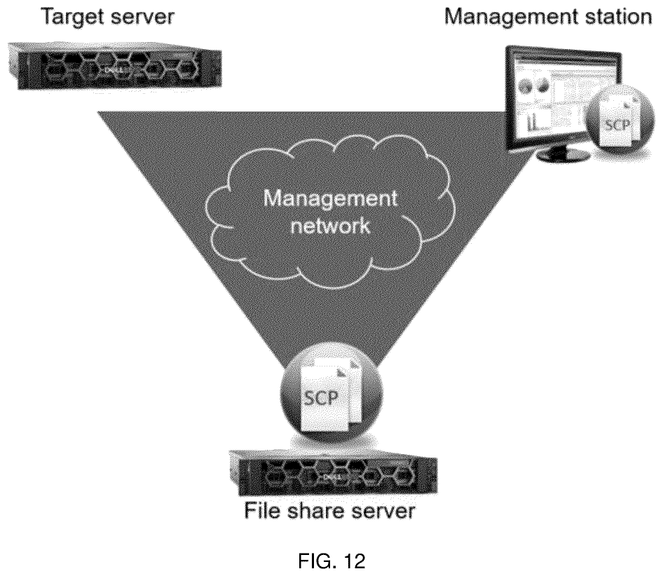

FIG. 12 is an exemplary diagram showing the server configuration automation function through Redfish in the IT asset management system according to the embodiment of the present invention.

In the present invention, the management server 110 can provide a server configuration automation function through the Redfish. Unique setting values of the server are stored as metadata of SCP (Server Configuration Profile), and the metadata can be configured by using the Redfish API in the present invention. The SCP can be exported, previewed, and imported, and by using this function, the configuration information can be applied to a newly built server through the server configuration automation function in the present invention.

The SCP can be shared through HTTPS, NFS, CIFS, and the like and is implemented in XML and JSON format. When configuring a server, a number of applications can be distributed reliably and consistently through the SSH protocol.

In the present invention, unique setting values for physical server distribution can be stored as metadata in XML and JSON format on a file sharing server, and the configuration information can be automatically applied to a newly built server connected to the management network. In this way, through the configuration automation function in the present invention, the operator can quickly configure a new server without separately connecting to each server to configure the new server.

In one embodiment of the present invention, an AI (Artificial Intelligence) analysis function using the Redfish is provided. In other words, through SRC (Server remote control) (iDRAC, iLO, and IPMI), structured log data and unstructured log data of the servers and the storage devices can be collected, and data classification and preprocessing can be performed. Afterwards, by utilizing the learning data model, the status and fault of the device are predicted and, when an important issue occurs, an alert message is transferred to the user terminal through a text message or an email.

In the present invention, through the AI analysis function, by learning what normal traffic is, discovering abnormal traffic, and setting a level of risk priority required for the users, problems can be analyzed and supported. Then, provided is a solution to a fault of analyzing and learning the logs collected during server operation and developing an algorithm through AI and transferring an alarm message to the customer terminal 130 when log information similar to the occurrence of an existing fault is confirmed through the learned algorithm. In other words, through the AI analysis function, occurrence and quick sharing of an issue of preventing faults proactively, real-time analysis, and the like can be performed.

The management server 110 may inspect the BBU (Backup Battery Unit) cycle of the management target server and, when a predetermined cycle is reached, transmit this information to the customer terminal in the relevant management target server.

In addition, the management server 110 may inspect a BBU charging capacity of the management target server and, when the battery charging efficiency is decreased to a predetermined value or less, notify the customer terminal in the relevant management target server of the contents. For example, the management server 110 may inspect a BBU charging capacity of the management target server and, when a battery charging efficiency is decreased to 40% or less, notify the customer terminal in the relevant management target server of the contents.

The management server 110 may inspect a remaining BBU capacity of the management target server and, when the remaining battery capacity is a predetermined value or less, notify the customer terminal in the relevant management target server of the contents. For example, the management server 110 may inspect the remaining capacity of the BBU of the management target server and, when the remaining battery capacity is 10% or less, notify the customer terminal in the relevant management target server of the contents.

In addition, the management server 110 may inspect the BBU write policy of the management target server and, when the write policy is changed, notify the customer terminal in the relevant management target server of the contents.

The present invention is about a server integrated management system of integrating and managing a number of servers diagnoses various functions of the servers, predicts faults in advance, warns, and provides a solution to the fault. In the present invention, among the various functions of the server, the BBU (Backup Battery Unit) will be described as an example.

For example, in a Dell server, in order to prevent loss of cache data due to a battery fault of the RAID controller, it is necessary to inspect the status of the BBU battery and proactively replace the BBU battery. To this end, a battery full charging efficiency (%) is confirmed through the log confirmation of the Dell server and, when a device with a full charging efficiency of less than 50% is confirmed, and battery replacement is performed.

After 36 months, the battery charging efficiency is naturally decreased to around 70%, and by taking this into account, a battery with an additional decrease of approximately 20% can be determined to a poor charging efficiency.

The server integrated management system of the present invention performs BBU cycle inspection, charging capacity inspection, remaining capacity inspection, and write policy inspection, and through these inspections, the server integrated management system can prevent cache data loss and can proactively prevent risk factors for the battery status.

In the IT asset management system of the present invention, when an event occurs, it is diagnosed that a server fault may occur through the event, the system of the server is warned in advance, and information about a solution is transferred. In this regard, the events occurring on the server are very diverse, and new events that have never existed before may newly occur.

Now, in the present invention, several events among the events that can occur in such servers are exemplified.
1. Fan (FAN) Noise (Reading 12,000 RPM or higher)

As a solution to this problem, it is recommended to downgrade to iDRAC7 version 1.46.45.
2. Occurrence of Shifting of Power Usage Ratio from Rack PDU #1 and PDU #2 towards PDU #1

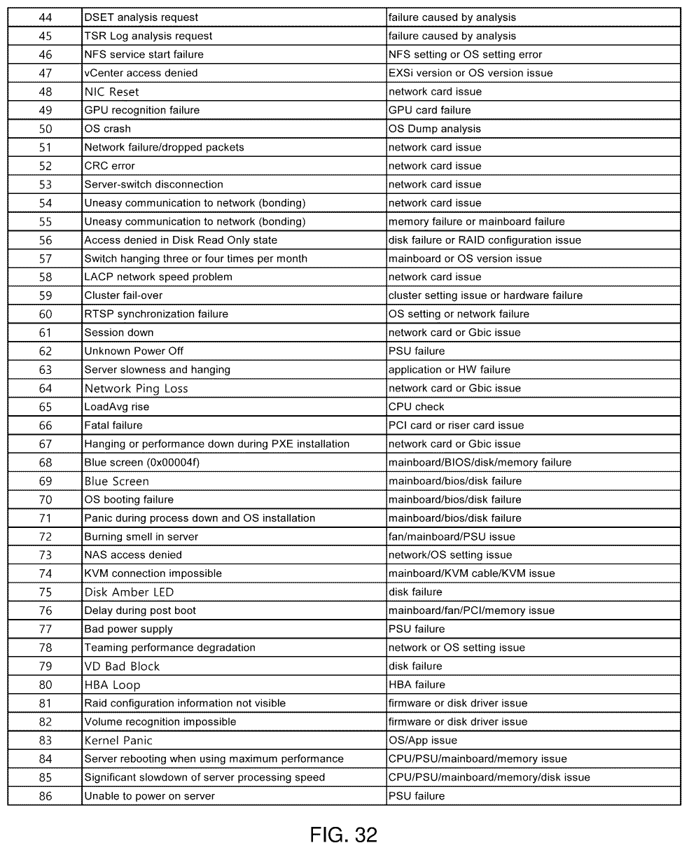

Referring to FIG. 32, not only the Dell server but also the HP server is set so as to operate in Active Standby as the default power supply, which causes power to be shifted to one side of the Rack PDU, and thus, for achieving balance, it is necessary to match with ratios between Primary and PSU.
3. OS Abnormal Operation after Kernel Update for 12th to 14th Generation Dell Server Products

At this time, if an abnormal operation is found on the OS (Operating System) after the kernel update in the Dell server, the management server 110 transmit a message of occurrence of a predicted fault that may occur due to this abnormal operation to the relevant management target server, and along with this message, a solution to the predicted fault is transferred to the relevant management target server.
4. Service Unavailable due to Lack of TCP/IP Ports

This is a phenomenon in which the Network TIME_WAIT session cannot be closed and remains when the uptime is 497 days or more in Windows 2008.

Due to this phenomenon, a problem occurs when the port is occupied and there are no more ports.

Windows 2008 servers and Windows 2012 servers are targeted, and the fault can be resolved by deleting the updated patch.
5. Occurrence of Windows 2003 ˜ 2022 event logs
6. Diagnosis of Memory Production Cycle

This confirms that a specific production cycle of a specific memory is defective, and the targets of the fault is 13th generation devices (R730, R930, and R630), and the fault OS is a Windows 2012, the R2 server is a server containing the KB3064209 hotfix, and the solution is to remove the hotfix.

In the present invention, the management server 110 diagnoses the memory production cycle of the management target server, determines that the predetermined memory production cycle is defective, and notifies the management target server of the contents.
7. Phenomenon of Stopping Response in Device Settings When using PCIe type SSD

The solution to this is to update BIOS 1.1.4 to 1.2.10.
8. Issue where Temperature Sensor does not Function Properly after 12G Server BIOS Update and Continuous Occurrence of Warning Sound (Alert_)

The solution to this is to diagnose BIOS version 2.5.2 and update to the latest firmware.
9. Phenomenon of being Unable to boot after Occurrence of BSOD after Patch Update

This event is a phenomenon caused by Windows error KB2982791 in the August 2014 Patch Tuesday update

The target of the fault is the Windows 2008 server, and the fault can be resolved through a patch update.
10. Occurrence of DNS Connection Error on Client Using Windows 2012 Active Director

When logging in with a domain account on the server, an error occurs saying “the user name or password is incorrect” even though the account and password are correct.

Starting with Windows Server 2008 R2/Windows 7, without using DES-CBC-MD5 and DES-CBC-CRC encryption, the only encryption of AES256-CTS-HMAC-SHA1-96 encryption, AES128-CTS-HMAC-SHA1-96 encryption and RC4-HMAC encryption is used. When the AD server is Windows Server 2012 R2 and the domain member is Windows Server 2008 R2 or Windows 7, this fault is a phenomenon occurring due to an issue on the product which the ARS key generation fails when updating the password for the computer account.
11. Vulnerability Existing in GNU Bash 4.3 Shell

It is known that, by using Bash vulnerabilities, attackers can change the contents and code of a web server, modify a website, leak user data, and perform DDOS attacks.

In addition to this, a situation is such that attack scenarios involving Bash code injection vulnerabilities under various environments such as SSH and DHCP protocols are also proposed.

The target of the fault is Red Hat Enterprise Linux 5, 6, and 7 servers, and the solution to the problem is Bash update.
12. Buffer Overflow Vulnerability in the GNU C library (glibc)

This fault is a phenomenon in which a vulnerable function is called when the gethostbyname( ) and gethostbyname2( ) functions frequently used during connecting to a network, and an external attacker can remotely execute arbitrary code on a vulnerable server.

The target of the problem is Red Hat Enterprise Linux 5, 6, and 7 servers, and the solution to the problem is GLIBC update.
13. Bug in Radhat V5 and V6 series OS

This is a bug that is an occurrence of reboot after 208.5 days in all versions of Red Hat Enterprise Linux 6 or 5 that use Intel CPUs.

The target of the problem is Red Hat Enterprise Linux 5 and 6 servers, and the solution to the problem is kernel update.
14. Raid Controller Battery Fail

I/O performance deteriorates due to unavailability of Raid Controller Cache.

The target of the fault is a Raid Controller Battery for Dell Perc 5i and 6i, and a solution to the fault is to replace the Raid Controller Battery for Dell Perc 5i and 6i every 4 to 5 years proactively.
15. System down due to occurrence of CPU IERR error

The target of the fault is a server (PE R720, PE R920) using CPUs using Intel iBridge V2, and the solution to the fault is to change the BIOS settings.

For example, in system profile settings, a system profile is set to a

custom, a CPU Power Management is set to Maximum Performance, C1E is set to disabled C states disabled, and Monitor/Mwait is set to disabled.
16. Management Web Connection Inability when Using iDrac 1.50.50 F/W (Firmware) (Search for Relevant Version)

F/W upgrading on the iDrac F/W (Firmware) OS or Upgrading to 1.51.51 by upgrading is performed though upgrading through media in daily life.

The present invention proposes an IT asset management system supporting multi-vendor. For example, in the present invention, information about hardware systems from three companies such as Dell, HP, and Lenovo is stored in one inventory, and all information about the hardware can be queried by using the information stored in the inventory so that the functions can be implemented so as to be utilized. For convenience of the description in the present invention, the IT asset management system supporting multi-vendors will be described by exemplifying manufacturers such as Dell, HP, and Lenovo.

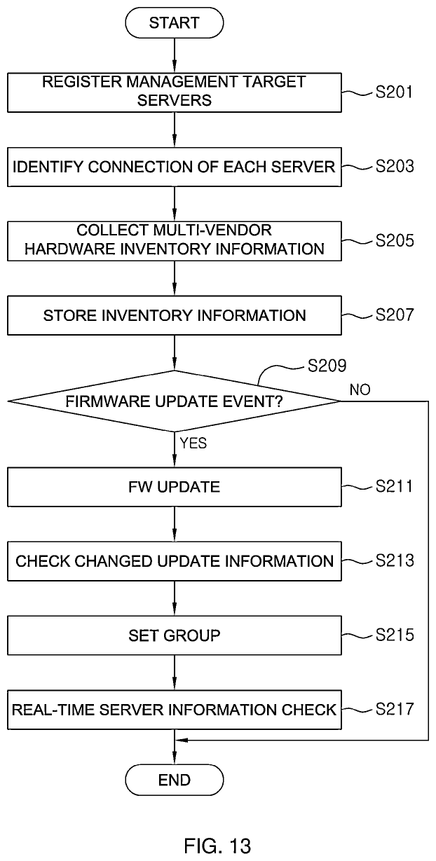

FIG. 13 is a flowchart exemplarily showing a method for managing servers by supporting multi-vendors in the IT asset management system according to the embodiment of the present invention. In FIG. 13, the entity performing each step is the management server 110.

Referring to FIG. 13, the management target server is registered (S201). At this time, the target server can be registered by using the management IP information of each server. For example, a target server can be registered by using iDRAC for the case of Dell, iLO for the case of HP, and iMM for the case of Lenovo.

Next, it is identified whether or not each server is connected (S203) and multi-vendor hardware inventory information is collected (S205). In one embodiment of the present invention, by using Redfish API (Application Programming Interface), which is a common hardware standard, inventory information about a hardware system of an x86 server can be collected regardless of manufacturers.

Then, the collected inventory information is stored (S207). When there is a firmware update event including an emergency firmware update, the firmware update is performed on all the management target servers (S209). Then, the changed update information is confirmed (S211). In one embodiment of the present invention, firmware update information can be confirmed through the Redfish API. Then, groups are set according to safety of each server, whether or not to b inspection target, status, importance, and the like (S215), and server information is confirmed in real time (S217). In this way, in one embodiment of the present invention, by using the Redfish API, various information about the x86 server in operation, such as detailed hardware specifications, OS (Operating System) information, firmware information, driver information, and the like can be collected for each server, and the standardization management of the x86 server can be performed.

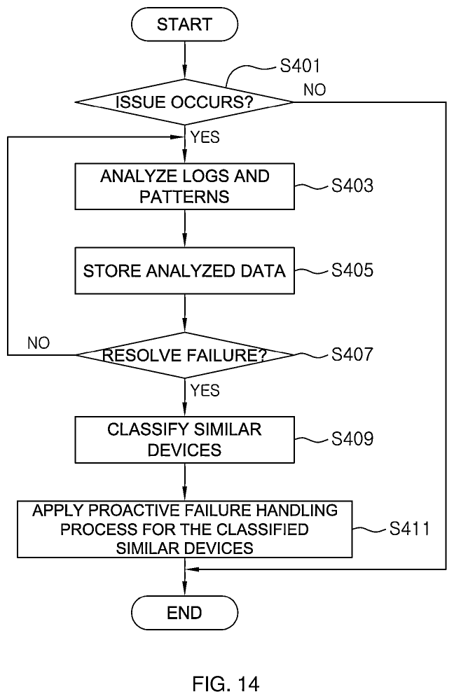

FIG. 14 is a flowchart exemplarily showing a method for preventing faults proactively by analyzing logs and patterns of faults in the IT asset management system according to the embodiment of the present invention. In FIG. 14, the entity performing each step is the management server 110.

Referring to FIG. 14, when an issue of the fault occurs in any device of the management target server (S401), logs and patterns are analyzed (S403). And, the analyzed data is stored (S405). When the issue of the fault is resolved (S407), a device similar to the relevant device is classified (S409), and fault response processing is performed proactively for the similar device classified in (S411). In this way, in the present invention, when the issue of the fault occurs, logs and patterns are analyzed and similar device is automatically classified, so that faults occurring in the similar device can be prevented proactively.

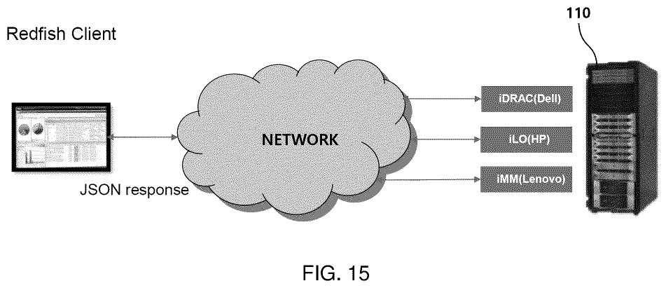

FIG. 15 is a diagram exemplarily showing an operation model supporting multi-vendors by using the Redfish API in the IT asset management system according to the embodiment of the present invention. As shown in FIG. 15, in the present invention, by using the Redfish API, inventory information about the x86 server hardware systems can be collected regardless of manufacturer, such as Dell, HP, or Lenovo, and the collected information can be queried and utilized. For example, in the case of Dell, data is collected by using iDRAC; in the case of HP, data is collected by using iLO; and in the case of Lenovo, data is collected by using iMM. And, by using the Redfish API, OS and firmware can be distributed and installed on a number of the servers.

In addition, in the present invention, by using the Redfish API, the hardware specifications, the OS information, the firmware information, and the like of each server can be quickly confirmed.

In addition, in the present invention, by analyzing patterns, faults can be predicted, and by using hardware logs, pattern analysis can be performed.

The Redfish API has been continuously updated since its first release in 2015, has supported multiple server manufacturing vendors, and has provided the same functions as IPMI. In addition, the Redfish API supports a BIOS and Secure Boot settings function, a firmware updating function, and a storage-server networking settings function. In addition, Open Compute Platform, Open stack, and SNIA (Storage Networking Industry Association) are supported, and network switch management, external storage management, and the like are supported.

IDRAC, which is a management tool for Power edge servers, supports the Redfish RESTful API by utilizing the Redfish. For example, the iDRAC can perform checking of server power (Reset, Reboot, and Power Control), server hardware inventory, server monitoring, and status, system log collecting, and confirming and alarming of server status change.

The PowerEdge servers can automate initial server setting through the Redfish. In addition, various configuration information such as iDRAC initial settings, BIOS, RAID controller, and network card can be templated, and automated distribution of the server can be performed.

Among examples of the Redfish usage in the iDRAC of the PowerEdge server, server configuration automation (Auto deployment) is exemplarily shown as follows. The unique setting values of the server are stored as metadata in the SCP (Server configuration profile), which can be configured with the Redfish API. And, through the Redfish API, various setting information such as BIOS, iDRAC/LC, PERC RAID Controller, NIC, and HBA can be set. The SCP can be exported, previewed, and imported, and the configuration information can be freely applied to a newly built server. The SCP can be shared through methods such as HTTS, NFS, and CIFS, and can be implemented in XML and JSON file formats.

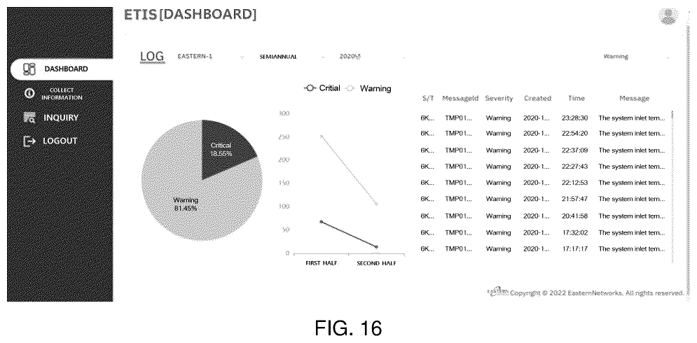

FIGS. 16 to 29 are diagrams showing screen examples of the server integrated monitoring system according to the embodiment of the present invention.

FIG. 16 is an initial screen example and is a screen example supporting through a dashboard so that information about inventory and logs automatically collected for the management target servers can be viewed at a glance.

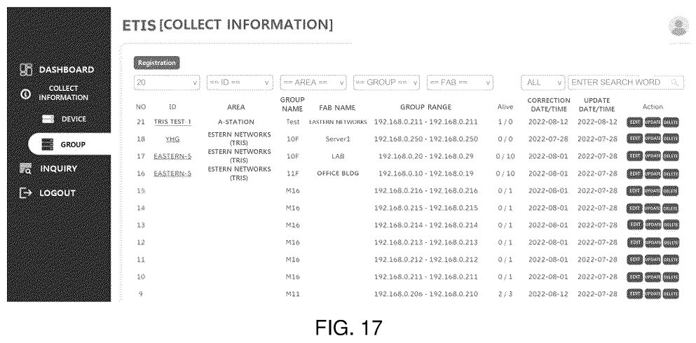

FIG. 17 is a screen example where the inventory information of the management target server can be confirmed in real time, and in this screen example, the inventory information is automatically changed for the changed information.

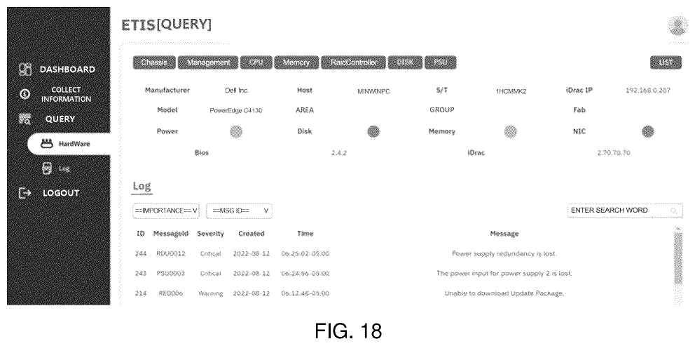

In the screen example of FIG. 18, when an issue in the management target server is confirmed, for easy recognition, each part is displayed with a symbol 5 ( [symbol] ) and normal parts are displayed with symbol 6 ( [symbol] )

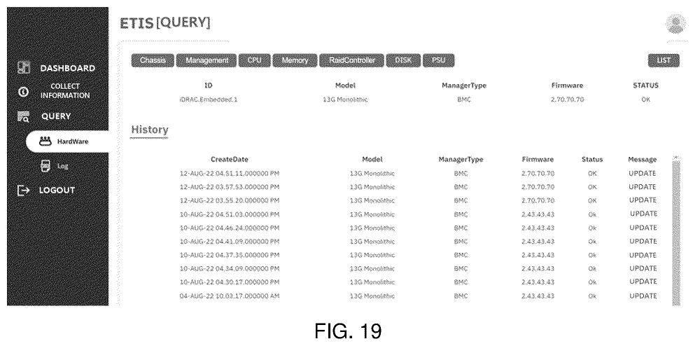

FIG. 19 is a screen example where the real-time management information of all the management target servers, including firmware (F/W) information can be confirmed.

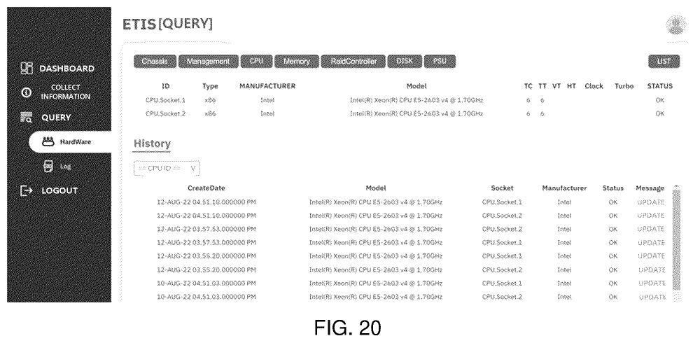

FIG. 20 is a screen example where the real-time CPU detailed information and the current status of all the management target servers can be confirmed.

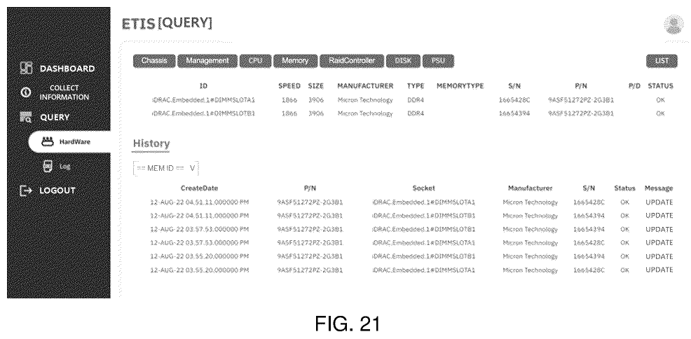

FIG. 21 is a screen example where the real-time memory detailed information and the current status of all the management target servers can be confirmed.

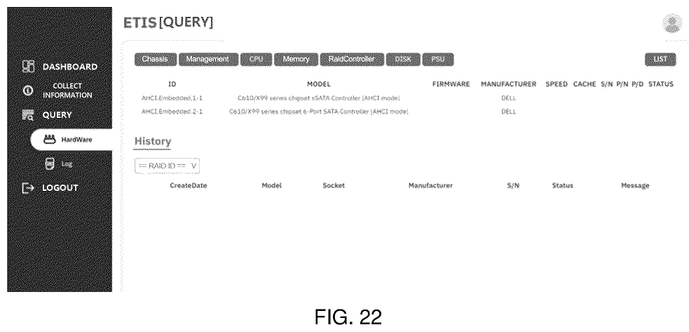

FIG. 22 is a screen example where the real-time Raid Controller detailed information and the current status of all the management target servers can be confirmed.

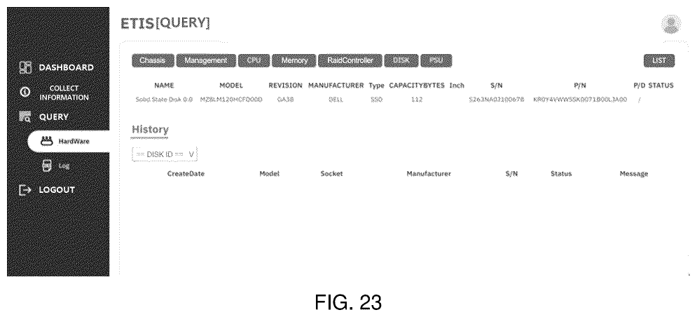

FIG. 23 is a screen example where the real-time disk detailed information and the current status of all the management target servers can be confirmed.

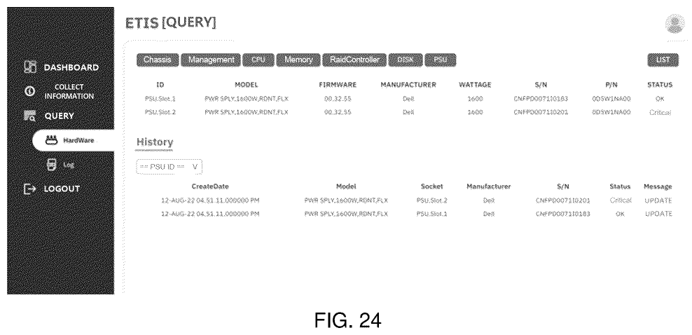

FIG. 24 is a screen example where the real-time detailed information and current status of the PSU (Power supply) of all the management target servers can be confirmed.

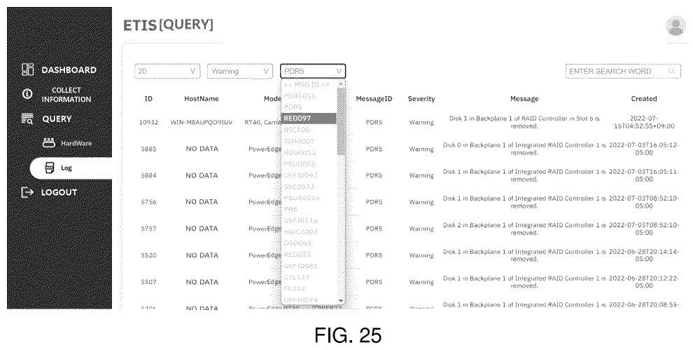

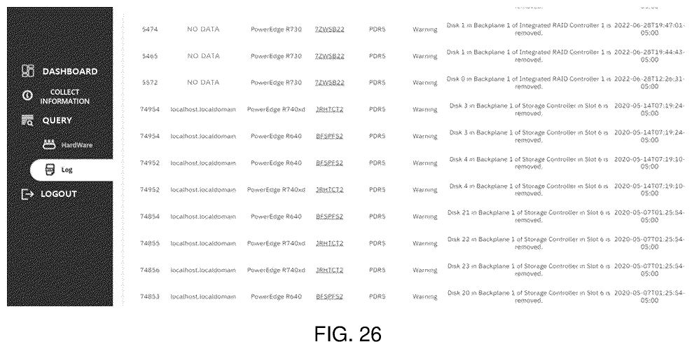

FIGS. 25 and 26 are screen examples where the real-time detailed information about the collected logos of all the management target servers can be confirmed and can collect and automatically classify the real-time vendor HW error codes and can confirm the issue devices for each error code.

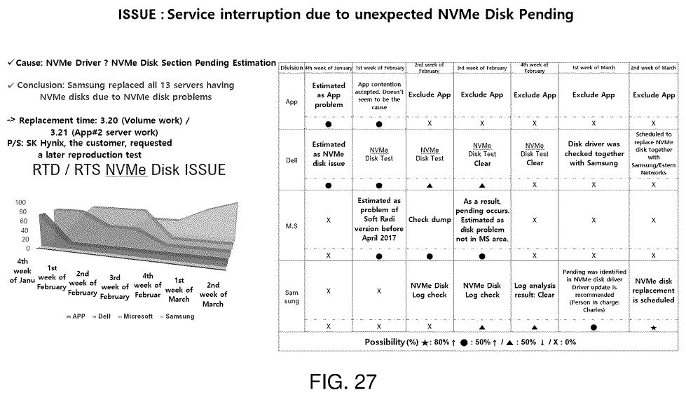

FIG. 27 is a fault analysis screen example displaying fault analysis information including the cause of the fault, results, and replacement time.

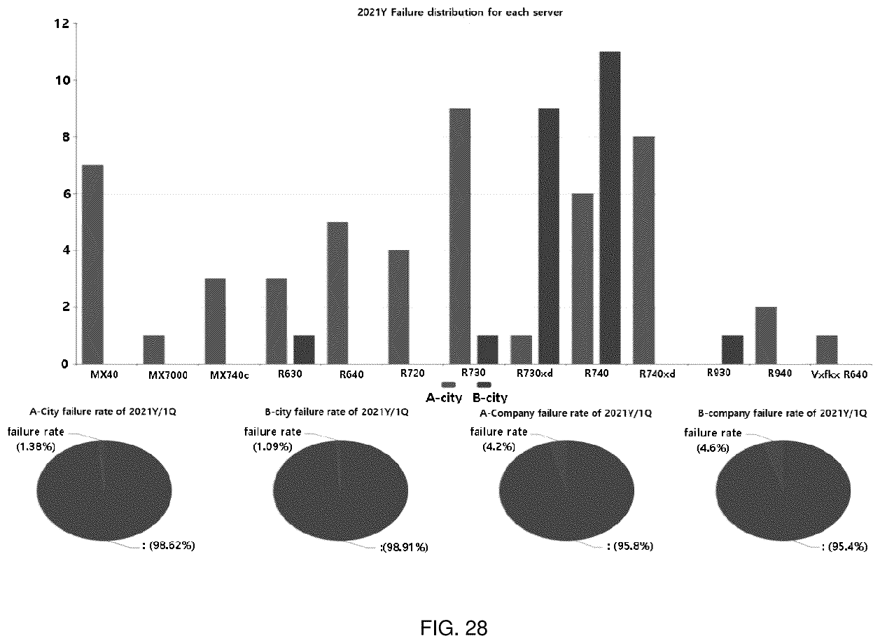

FIG. 28 is a screen example exemplarily showing a fault analysis distribution diagram for each server compared to customer companies.

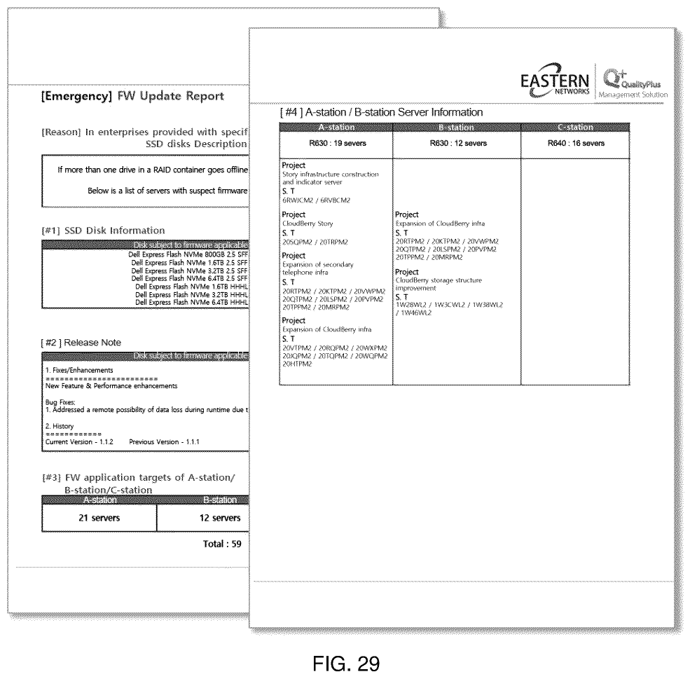

FIG. 29 is a screen example exemplarily showing the service report function, and the contents of the report including issues at the time of occurrence, problem resolution, and details of measures to prevent recurrence are exemplarily shown.

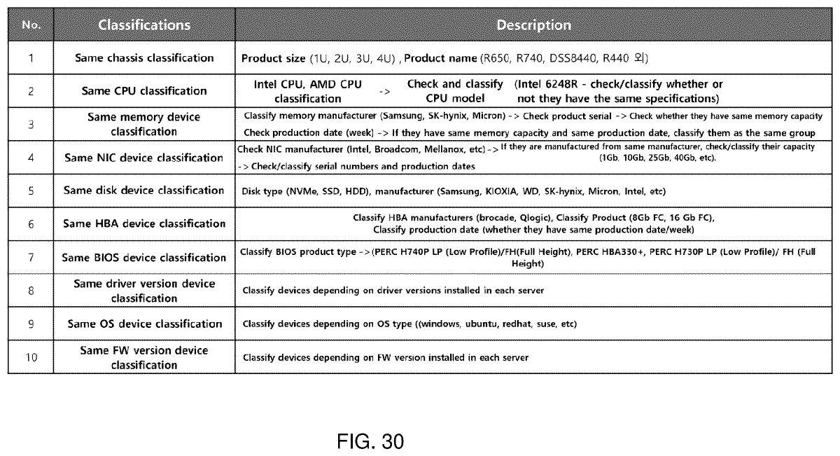

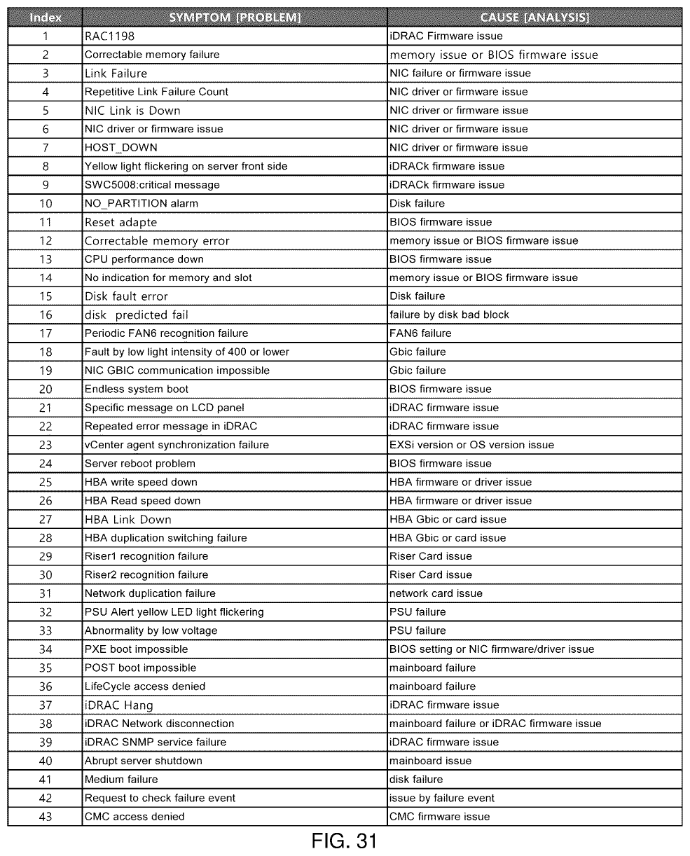

FIG. 30 is a table classifying system devices according to the embodiment of the present invention, and FIGS. 31 and 32 are tables describing hardware symptoms and their causes according to the embodiment of the present invention.

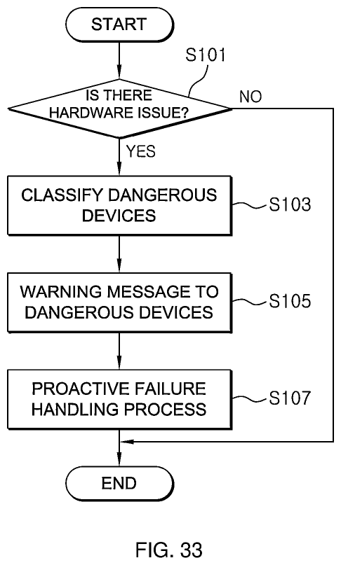

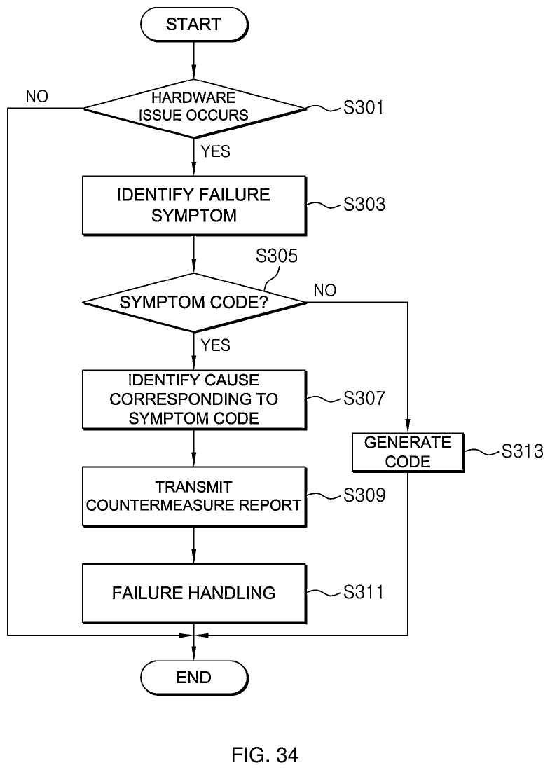

FIGS. 33 and 34 are flowcharts showing a method for responding to faults proactively in the IT asset management system according to the embodiment of the present invention.

Referring to FIG. 33, when a hardware-related issue occurs in the management target server (S101), the management server 110 classifies a similar device with a high probability of occurrence of fault as a hazardous device with reference to the classification table of FIG. 30 (S103). Then, an alert message for classified hazardous device is transmitted (S105), and fault response measures are performed proactively (S107).

Referring to the classification table of FIG. 30, specific similarity determination criteria for system devices in the embodiment of the present invention are exemplarily shown, and classification of the same class device, classification of the same CPU device, classification of the same Memory device, classification of the same NIC device, classification of the same Disk devices, classification of the same HBA devices, classification of the same BIOS devices, classification of the same Driver version device, classification of the same OS device, classification of the same Firmware version device, and the like are exemplarily shown.

Referring to FIG. 34, when a hardware-related issue occurs in the management target server (S301), the management server 110 identifies fault symptoms (S303).

Then, with reference to the tables of FIGS. 31 and 32, the symptom code according to the fault symptom is confirmed (S305). Then, the cause corresponding to the symptom code is confirmed (S307), and a counter-measure report is transmitted accordingly (S309). Then, fault response measures corresponding to the cause of the fault is performed (S311).

When there is no symptom code corresponding to the fault symptom in step S305, a new symptom code is generated and added to the list of FIGS. 31 and 32 (S313).

Referring to FIGS. 31 and 32, the fault cause corresponding to the symptom code for each fault symptom according to the embodiment of the present invention is exemplarily shown. In other words, RAC1198 is caused by an issue with iDrac firmware; connectable memory fault is caused by an issue with memory and an issue with BIOS firmware; occurrence of Link Fault is caused by an issue with NIC fault and firmware; occurrence of a number of Link Fault Counts is caused by an issue with NIC driver and firmware; NIC Link Is Down is caused by an issue with the NIC driver and firmware; Link status and server inspection request are caused by an issue with the NIC driver and firmware; occurrence of HOST_DOWN is caused by an issue with the NIC driver and firmware; occurrence of Yellow lighting on the front of the server is caused by an issue with the iDrac firmware; SWC5008: Critical message output is caused by an issue with iDrac firmware; occurrence of NO_PARTITION alarm is caused by a disk fault; Reset adapte is caused by an issue with BIOS firmware; Correctable memory error is caused by an issue with memory and an issue with BIOS firmware; CPU performance degradation is caused by an issue with BIOS firmware; Memory and Slot Not displayed is caused by an issue with memory or an issue with BIOS firmware; Disk fault error is caused by a disk fault; disk predicted fail is caused by a fault due to disk BadBlock; cyclic FAN 6 recognition problems is caused by a Fan 6 fault; a fault due to light intensity of 400 or less is caused by a Gbic fault; NIC GBIC communication inability is caused by a Gbic fault; infinite rebooting of the system is caused by an issue with the BIOS firmware; LCD Panel-specific message output is caused by an issue with the iDrac firmware; occurrence of repeated error messages from iDRAC is caused by an issue with the iDrac firmware; synchronization errors with vCenter agent is caused by an issue with the EXSi version and OS version issues; server reboot phenomenon is caused by an issue with BIOS firmware; HBA Write speed slowdown is caused by an issue with HBA firmware and driver; HBA Read speed slowdown is caused by an issue with HBA firmware and driver; HBA Link Down is caused by an issue with HBA Gbic and Card; HBA redundancy transfer fault is caused by an issue with the HBA Gbic and Card; poor recognition of Riser1 is caused by an issue with the Riser Card; poor recognition of Riser2 is caused by an issue with the Riser Card; network redundancy fault is caused by an issue with the Network Card; PSU Alert yellow LED lighting is caused by a PSU fault; occurrence of abnormality due to low voltage is caused by PSU fault; PXE booting inability is caused by an issue with not possible due to BIOS settings and NIC firmware/driver; POST booting inability is caused by not possible due to main board fault; LifeCycle connection inability is caused by not possible due to mainboard fault; iDRAC Hang symptom is caused by an issue with iDrac firmware; iDRAC Network disconnection is caused by Main board fault and an issue with iDrac firmware; occurrence of iDRAC SNMP service fault is caused by an issue with iDrac firmware; symptom of server suddenly turning off while in use is caused by an issue with main board; occurrence of Medium Error is caused by a disk fault; ERROR Event confirmation request is caused by an error Event; CMC connection inability is caused by an issue in the CMC firmware.

In addition; a DSET analysis request is caused by a fault due to analysis; a TSR Log analysis request is caused by a fault due to analysis; NFS service startup failure is caused by inspection of NFS settings and OS settings; vCenter connection inability is caused by an issue with EXSi version and OS version; NIC Reset is caused by an issue with Network Card; GPU recognition inability is caused by a GPU card fault; occurrence of OS Crash is caused by OS Dump analysis; occurrence of Network error/dropped packets is caused by an issue with Network Card; occurrence of CRC error is caused by an issue with Network Card; a phenomenon of disconnection of server-switch is caused by an issue with Network Card; a problem with poor communication to the network (Bonding) is caused by an issue with network card; occurrence of the same slot event after memory replacement is caused by a memory fault or main board fault; access inability in Disk Read Only state is caused by a disk fault or RAID configuration issues; symptom of switch hangs 3-4 times a month is caused by an issue with the main board or OS version; occurrence of LACP network speed problem is caused by issues with the network card; occurrence of cluster failovers is caused by an issue with cluster settings or HW fault; RTSP Synchronization failure is caused by OS settings or network fault; occurrence of session degradation phenomenon is caused by an issue with Network Card or Gbic; unknown power cut is caused by PSU fault; server slowdown and hang phenomenon is caused by application or HW fault; Network Ping Loss is caused by an issue with Network Card or Gbic; Issue; LoadAvg increasing is caused by requiring CPU inspection; occurrence of Fatal Error is caused by an issue with PCI Card or Riser Card; stopping or performance decrease during PXE installation is caused by an issue with Network Card or Gbic; occurrence of Blue Screen (0x00004f) is caused by Main board/BIOS/disk/memory fault; Blue Screen is caused by main board/BIOS/disk fault; OS booting failure is caused by main board/BIOS/disk fault; process down and panic during OS installation is caused by main board/BIOS/disk fault; burning smell from the server is caused by an issue with the fan/main board/PSU; NAS connection inability is caused by an issue with network/OS settings; KVM connection inability is caused by an issue with the main board/KVM cable/KVM; Disk Amber LED is caused by a disk fault; Delay during post booting is caused by an issue with the mainboard/fan/PCI/memory; poor measures of power supply is caused by a PSU fault; poor teaming performance is caused by an issue with network/OS settings; VD Bad Block is caused by a disk fault; HBA Loop is caused by a HBA fault; invisibility of Raid configuration information is caused by an issue with firmware/disk driver; Volume recognition inability is caused by an issue with firmware/disk driver; Kernel Panic is caused by an issue with OS/App; server rebooting when using maximum performance is caused by an issue with CPU/PSU/main board/memory; significantly slowdown of server processing is caused by an issue with CPU/PSU/mainboard/memory/disk; and server not powered on is caused by PSU fault. The present invention has been described above by using several preferred examples, but these examples are illustrative and not limiting. The ordinarily skilled persons in the technical field to which the present invention relates will understand that various changes and modifications can be made without departing from the spirit of the present invention and the scope of rights set forth in the appended claims.

What is claimed is:

1. An IT asset management system for managing an IT asset including two or more management target servers, comprising:
a database for storing data related to the management target servers; and
a management server collecting a hardware-related data and a software-related data from the management target servers, monitoring and managing a status of each management target server, and providing various server monitoring information, including management service statistical data and management service reports, to an administrator terminal used by an administrator and a customer terminal requesting the management target server, wherein the management server provides a server configuration automation function in a way where unique setting values of each management target server are stored as a metadata in a SCP (Server configuration profile).

2. The IT asset management system according to claim 1, wherein the management server provides the server configuration automation function by using Redfish API.

3. The IT asset management system according to claim 2, wherein the management server distributes SCP to the management target server newly built so that configuration information is applied.

4. The IT asset management system according to claim 1, wherein the management server inspects a BBU (Backup Battery Unit) cycle of the management target server and, when a predetermined cycle is reached, transmits this content to the customer terminal in the relevant management target server,
wherein the management server inspects a BBU charging capacity of the management target server and, when a charging efficiency of a battery is decreased to a predetermined value or less, notifies the customer terminal in the relevant management target server of this content,
wherein the management server inspects a remaining BBU capacity of the management target server and, when the remaining battery capacity is a predetermined value or less, and notifies the customer terminal in the relevant management target server of this content,
wherein the management server inspects a BBU write policy of the management target server and, when the write policy is changed, notifies the customer terminal in the relevant management target server of this content, and
wherein the management server confirms a battery full charging efficiency (%) through log confirmation of the management target server, and notifies the customer terminal in the relevant management target server of a message notifying battery replacement for device of which a full charging efficiency is less than a predetermined value.

5. The IT asset management system according to claim 1, wherein the management server collects and stores multi-vendor hardware inventory information from a plurality of registered management target servers.

6. The IT asset management system according to claim 5, wherein, when there is a firmware update event including an emergency firmware update, the management server performs a firmware update for all the management target servers.

7. The IT asset management system according to claim 1, wherein, when an issue of the fault occurs in any device of the management target server, the management server analyzes logs and patterns, stores the analyzed data and, when the issue of the fault is resolved, classifies devices similar to the relevant device, and performs pre-fault response processing proactively on the classified similar devices.

8. The IT asset management system according to claim 1, wherein, when a hardware-related issue occurs in the management target server, the management server classifies a similar device with a high probability of occurrence of fault as a hazardous device with reference to the classification table, transmits an alert message about the classified hazardous device, and performs the fault response measures proactively.

9. The IT asset management system according to claim 1, wherein the classification table includes specific criteria for determining the similarity of system devices, including classification of the same class devices, classification of the same CPU devices, classification of the same Memory devices, classification of the same NIC devices, classification of the same Disk devices, classification of the same HBA devices, classification of the same BIOS version devices, classification of the same driver version devices, classification of the same OS devices, and classification of the same firmware version devices.

10. The IT asset management system according to claim 9, wherein, when a hardware-related issue occurs in the management target server, the management server identifies a fault symptom, confirms a symptom code according to the fault symptom with reference to a list including a cause of the fault corresponding to a symptom code for each fault symptom, confirms the cause corresponding to the symptom code, transmits a counter-measure report accordingly, performs fault response measures corresponding to the cause of the fault, generates a new symptom code when there is no symptom code corresponding to the fault symptom, and adds the new symptom code to the list.

11. The IT asset management system according to claim 10, wherein, in the list, RAC1198 is caused by an issue with iDrac firmware; connectable memory fault is caused by an issue with memory and an issue with BIOS firmware; occurrence of Link Fault is caused by an issue with NIC fault and firmware; occurrence of a number of Link Fault Counts is caused by an issue with NIC driver and firmware; NIC Link Is Down is caused by an issue with the NIC driver and firmware; Link status and server inspection request are caused by an issue with the NIC driver and firmware; occurrence of HOST_DOWN is caused by an issue with the NIC driver and firmware; occurrence of Yellow lighting on the front of the server is caused by an issue with the iDrac firmware; SWC5008: Critical message output is caused by an issue with iDrac firmware; occurrence of NO_PARTITION alarm is caused by a disk fault; Reset adapte is caused by an issue with BIOS firmware; Correctable memory error is caused by an issue with memory and an issue with BIOS firmware; CPU performance degradation is caused by an issue with BIOS firmware; Memory and Slot Not displayed is caused by an issue with memory or an issue with BIOS firmware; Disk fault error is caused by a disk fault; disk predicted fail is caused by a fault due to disk BadBlock; cyclic FAN 6 recognition problems is caused by a Fan 6 fault; a fault due to light intensity of 400 or less is caused by a Gbic fault; NIC GBIC communication inability is caused by a Gbic fault; infinite rebooting of the system is caused by an issue with the BIOS firmware; LCD Panel-specific message output is caused by an issue with the iDrac firmware; occurrence of repeated error messages from iDRAC is caused by an issue with the iDrac firmware; synchronization errors with vCenter agent is caused by an issue with the EXSi version and OS version issues; server reboot phenomenon is caused by an issue with BIOS firmware; HBA Write speed slowdown is caused by an issue with HBA firmware and driver; HBA Read speed slowdown is caused by an issue with HBA firmware and driver; HBA Link Down is caused by an issue with HBA Gbic and Card; HBA redundancy transfer fault is caused by an issue with the HBA Gbic and Card; poor recognition of Riser1 is caused by an issue with the Riser Card; poor recognition of Riser2 is caused by an issue with the Riser Card; network redundancy fault is caused by an issue with the Network Card; PSU Alert yellow LED lighting is caused by a PSU fault; occurrence of abnormality due to low voltage is caused by PSU fault; PXE booting inability is caused by an issue with not possible due to BIOS settings and NIC firmware/driver; POST booting inability is caused by not possible due to main board fault; LifeCycle connection inability is caused by not possible due to mainboard fault; iDRAC Hang symptom is caused by an issue with iDrac firmware; IDRAC Network disconnection is caused by Main board fault and an issue with iDrac firmware; occurrence of iDRAC SNMP service fault is caused by an issue with iDrac firmware; symptom of server suddenly turning off while in use is caused by an issue with main board; occurrence of Medium Error is caused by a disk fault; ERROR Event confirmation request is caused by an error Event; CMC connection inability is caused by an issue in the CMC firmware; a DSET analysis request is caused by a fault due to analysis; a TSR Log analysis request is caused by a fault due to analysis; NFS service startup failure is caused by inspection of NFS settings and OS settings; vCenter connection inability is caused by an issue with EXSi version and OS version; NIC Reset is caused by an issue with Network Card; GPU recognition inability is caused by a GPU card fault; occurrence of OS Crash is caused by OS Dump analysis; occurrence of Network error/dropped packets is caused by an issue with Network Card; occurrence of CRC error is caused by an issue with Network Card; a phenomenon of disconnection of server-switch is caused by an issue with Network Card; a problem with poor communication to the network (Bonding) is caused by an issue with network card; occurrence of the same slot event after memory replacement is caused by a memory fault or main board fault; access inability in Disk Read Only state is caused by a disk fault or RAID configuration issues; symptom of switch hangs 3-4 times a month is caused by an issue with the main board or OS version; occurrence of LACP network speed problem is caused by issues with the network card; occurrence of cluster failovers is caused by an issue with cluster settings or HW fault; RTSP Synchronization failure is caused by OS settings or network fault; occurrence of session degradation phenomenon is caused by an issue with Network Card or Gbic; unknown power cut is caused by PSU fault; server slowdown and hang phenomenon is caused by application or HW fault; Network Ping Loss is caused by an issue with Network Card or Gbic; Issue; LoadAvg increasing is caused by requiring CPU inspection; occurrence of Fatal Error is caused by an issue with PCI Card or Riser Card; stopping or performance decrease during PXE installation is caused by an issue with Network Card or Gbic; occurrence of Blue Screen (0x00004f) is caused by Main board/BIOS/disk/memory fault; Blue Screen is caused by main board/BIOS/disk fault; OS booting failure is caused by main board/BIOS/disk fault; process down and panic during OS installation is caused by main board/BIOS/disk fault; burning smell from the server is caused by an issue with the fan/main board/PSU; NAS connection inability is caused by an issue with network/OS settings; KVM connection inability is caused by an issue with the main board/KVM cable/KVM; Disk Amber LED is caused by a disk fault; Delay during post booting is caused by an issue with the mainboard/fan/PCI/memory; poor measures of power supply is caused by a PSU fault; poor teaming performance is caused by an issue with network/OS settings; VD Bad Block is caused by a disk fault; HBA Loop is caused by a HBA fault; invisibility of Raid configuration information is caused by an issue with firmware/disk driver; Volume recognition inability is caused by an issue with firmware/disk driver; Kernel Panic is caused by an issue with OS/App; server rebooting when using maximum performance is caused by an issue with CPU/PSU/main board/memory; significantly slowdown of server processing is caused by an issue with CPU/PSU/mainboard/memory/disk; and server not powered on is caused by PSU fault.
